(19) United States
(12) Patent Application Publication
(10) Pub. No.: US 2010/0099029 A1
(43) Pub. Date: Apr. 22, 2010

(54) LITHIUM ION SECONDARY BATTERY

(76) Inventors: Masahiro Kinoshita, Osaka (JP); Masaya Ugaji, Osaka (JP)

Correspondence Address: MCDERMOTT WILL & EMERY LLP, 600 13TH STREET, NW, WASHINGTON, DC, 20005-3096, US

(21) Appl. No.: 12/578,837

(22) Filed: Oct. 14, 2009

(30) Foreign Application Priority Data
Oct. 17, 2008 (JP) 2008-268350

(51) Int. Cl. H01M 6/18

(52) U.S. Cl. 429/316; 429/306

(57) ABSTRACT

Disclosed is a lithium ion secondary battery including: a positive electrode including a positive electrode active material layer containing a positive electrode active material, and a positive electrode current collector; a negative electrode including a thin film negative electrode active material layer containing an alloy-based negative electrode active material, and a negative electrode current collector; a separator interposed between the positive electrode and the negative electrode; and an ion-permeable resin layer formed on a surface of the thin film negative electrode active material layer. In this lithium ion secondary battery, despite the use of the alloy-based negative electrode active material, the deterioration in battery performance such as cycle characteristics and output characteristics is prevented.

### FIELD OF THE INVENTION

The present invention relates to a lithium ion secondary battery. More specifically, the present invention mainly relates to an improvement of a lithium ion secondary battery including a positive electrode, a negative electrode, and a separator interposed therebetween, wherein the negative electrode contains an alloy-based negative electrode active material.

### BACKGROUND OF THE INVENTION

Lithium ion secondary batteries have a high capacity and a high energy density and are easily reduced in size and weight, and for this reason, have been widely used as power sources for portable electronic devices and the like. Examples of the portable electronic devices include cellular phones, personal digital assistants (PDAs), notebook personal computers, camcorders, and portable game machines. A typical lithium ion secondary battery includes a positive electrode containing a lithium cobalt composite oxide, a negative electrode containing a carbon material such as graphite, and a polyolefin porous film (a separator).

The alloy-based negative electrode active material absorbs lithium by alloying with lithium. The alloy-based negative electrode active material reversibly absorbs and desorbs lithium ions under negative electrode potential. Examples of the alloy-based negative electrode active material include silicon, tin, an oxide of these, and a compound or alloy containing these. The alloy-based negative electrode active material has a high discharge capacity. For example, the theoretical discharge capacity of silicon is about 4199 mAh/g, which is about 11 times as large as the theoretical discharge capacity of graphite. As such, the alloy-based negative electrode active material is effective in improving the capacity of lithium ion secondary batteries.

However, the alloy-based negative electrode active material expands and contracts in association with the absorption and desorption of lithium, and generates a comparatively large stress. Because of this, with the increase in the number of cycles of charge and discharge, cracks tend to occur on the surface of or inside the negative electrode active material layer containing the alloy-based negative electrode active material. When cracks occur, new surfaces which have not been in direct contact with the non-aqueous electrolyte will be created (hereinafter referred to as “newly created surfaces”).

When the newly created surfaces come in contact with the non-aqueous electrolyte, side reaction other than charge/discharge reaction occurs, and byproducts are likely to be formed. The byproducts expand abnormally, causing a shortened life of the electrode, a deformation of the battery, and the like. Moreover, the non-aqueous electrolyte is consumed by the side reaction, and the shortage of the amount of non-aqueous electrolyte in the battery occurs, causing the battery performance such as the cycle characteristics to deteriorate.

With regard to a negative electrode for a lithium ion secondary battery utilizing an alloy-based negative electrode active material, various proposals have been suggested.

Japanese Laid-Open Patent Publication No. 2005-197258 (hereinafter referred to as “Patent Document 1”) suggests a negative electrode including a negative electrode current collector, a negative electrode active material layer, and a resin layer. The negative electrode active material layer comprises a lithium alloy and a binder. The lithium alloy contains lithium, and tin or silicon. The resin layer is formed on the surface of the negative electrode active material layer and includes a polymer support and a cross-linkable monomer. The cross-linkable monomer is not only contained in the resin layer but also packed in the gaps in the negative electrode active material layer in the form of a cross-linked substance.

The cross-linkable monomer is an organic compound with ion conductivity and low electrical conductivity. Listed as examples of the cross-linkable monomer are hexyl acrylate, butyl acrylate, diallyl suberate, ethylene glycol dimethacrylate, tritetraethylene glycol diacrylate, polyethylene glycol di(metha)acrylate, diglycidyl ester, divinylbenzene, and the like; and as examples of the polymer support are polymethyl methacrylate, poly(meta)acrylic acid, polyethyl methacrylate, propylene carbonate methacrylate, and the like.

Japanese Laid-Open Patent Publication No. 2008-004534 (hereinafter referred to as “Patent Document 2”) suggests a negative electrode including a negative electrode current collector, a negative electrode active material layer, and an oxide film formed on the surface of the negative electrode active material layer. The negative electrode active material is an alloy-based negative electrode active material containing silicon or tin. The oxide film is formed by a liquid phase method and contains an oxide of element selected from silicon, germanium, and tin. The surfaces of the particles of the alloy-based negative electrode active material in the negative electrode active material layer are coated with the oxide film.

In lithium ion secondary batteries including the negative electrodes of Patent Documents 1 and 2, troubles such as a shortened life of the electrode and a deformation of the battery tend to occur. In addition, the battery performance such as cycle characteristics tends to deteriorate. Moreover, with the increase in the number of cycles of charge and discharge, the resin layer of Patent Document 1 tends to be separated from the surface of the negative electrode active material layer.

### BRIEF SUMMARY OF THE INVENTION

The present invention intends to provide a lithium ion secondary battery being excellent in battery performance such as cycle characteristics and output characteristics and having a long service life.

The present invention provides a lithium ion secondary battery. The lithium ion secondary battery of the present invention comprises a positive electrode, a negative electrode, a separator, and an ion-permeable resin layer. The positive electrode includes a positive electrode active material layer containing a positive electrode active material, and a positive electrode current collector. The negative electrode includes a negative electrode active material layer in the form of thin film (hereinafter referred to as a “thin film negative electrode active material layer) containing an alloy-based negative electrode active material, and a negative electrode current collector. The separator is interposed between the positive electrode and the negative electrode. The ion-permeable resin layer coats at least part of a surface of the thin film negative electrode active material layer.

The lithium ion secondary battery of an aspect of the present invention is excellent in battery performance such as cycle characteristics and output characteristics and has a long service life.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a longitudinal sectional view schematically showing a configuration of a flat lithium ion secondary battery according to one embodiment of the present invention;

FIG. 2 is a perspective view schematically showing a configuration of a negative electrode current collector;

FIG. 3 is a longitudinal sectional view schematically showing a configuration of a negative electrode including the negative electrode current collector shown in FIG. 2;

FIG. 4 is a longitudinal sectional view schematically showing a configuration of a column included in a thin film negative electrode active material layer of the negative electrode shown in FIG. 3;

FIG. 5 is a longitudinal sectional view schematically showing a configuration of a lithium ion secondary battery according to another embodiment of the present invention;

FIG. 6 is a longitudinal sectional view schematically showing a configuration of a main part of a negative electrode according to the another embodiment of the present invention;

FIG. 7 is a longitudinal sectional view schematically showing a configuration of a main part of another negative electrode according to the another embodiment of the present invention;

FIG. 8 is a side view schematically showing a configuration of an electron beam vapor deposition apparatus; and

FIG. 9 is a side view schematically showing a configuration of another vapor deposition apparatus.

### DETAILED DESCRIPTION OF THE INVENTION

In the bourse of studying for solving the problems of the conventional techniques, the present inventors have examined the reasons why the techniques of Patent Documents 1 and 2 fail to provide sufficient characteristics. The resin layer of Patent Document 1 is effective to some extent in preventing the newly created surfaces appearing on the surface of the negative electrode active material layer containing the alloy-based negative electrode active material from coming in contact with the non-aqueous electrolyte.

However, the negative electrode active material layer of Patent Document 1 includes particles of the alloy-based negative electrode active material and the binder, and has a comparatively smooth surface. Since the resin layer is formed on this comparatively smooth surface of the negative electrode active material layer, the adhesion between the negative electrode active material layer and the resin layer becomes insufficient. Moreover, due to the changes in volume of the alloy-based negative electrode active material, the adhesion between the negative electrode active material layer and the resin layer is further reduced. As a result, the resin layer tends to be separated from the negative electrode active material layer.

For this reason, the resin layer of Patent Document 1 cannot prevent the newly created surfaces appearing inside the negative electrode active material layer from coming in contact with the non-aqueous electrolyte. Consequently, according to the technique of Patent Document 1, side reaction due to the contact of the newly created surfaces with the non-aqueous electrolyte is likely to occur.

Further, this presumably results in a shortened life of the electrode, a deformation of the battery, a deterioration of the battery performance such as the cycle characteristics, and other troubles.

According to Patent Document 2, the surfaces of the particles of the alloy-based negative electrode active material in the negative electrode active material layer are coated with an oxide film. However, the mechanical strength of the oxide film is not high enough to prevent the expansion of the particles of the alloy-based negative electrode active material, and therefore, the particles of the alloy-based negative electrode active material inside the negative electrode active material layer will inevitably have newly created surfaces. The oxide film is not as elastic as the resin layer, and therefore, once the particles of the alloy-based negative electrode active material have newly created surfaces, the contact of the newly created surfaces with the non-aqueous electrolyte cannot be prevented. Presumably for the reasons above, the above-discussed troubles occur.

The present inventors have paid attention to the following points 1) to 3): 1) Alloy-based negative electrode active materials have a considerably larger capacity than carbon materials such as graphite;

2) By allowing an alloy-based negative electrode active material to deposit on the surface of a current collector, a thin film negative electrode active material layer that does not contain a binder can be formed; and

3) Thin-film negative electrode active material layers containing an alloy-based negative electrode active material have a high capacity and a high energy density and are capable of improving the capacity and output power of lithium ion secondary batteries.

The present inventors have further studied on the basis of the findings regarding Patent Documents 1 and 2 and the above points 1) to 3), and eventually found that in a thin film negative electrode active material layer having a thickness of about 1 μm to several tens μm formed by a vapor phase method, if newly created surfaces are created, most of the newly created surfaces are exposed on the surface of the thin film negative electrode active material layer. The present inventors have further found that the surface of a thin film negative electrode active material layer formed by depositing an alloy-based negative electrode active material on the surface of a current collector by a vapor phase method has an adequate surface roughness.

On the basis of these results of studies, the present inventors have conceived of forming an ion-permeable resin layer on the surface of a thin film negative electrode active material layer formed by a vapor phase method. The surface of the thin film negative electrode active material layer has an adequate surface roughness. The thin film negative electrode active material layer, therefore, has a good adhesion with the ion-permeable resin layer, making it possible to prevent the ion-permeable resin layer from being separated from the thin film negative electrode active material layer. In addition, most of the newly created surfaces are exposed on the surface of the thin film negative electrode active material layer, making it possible for the ion-permeable resin layer to sufficiently prevent the newly created surfaces from coming into contact with the non-aqueous electrolyte. As a result, a shortened life of the electrode, a deformation of the battery, a deterioration of the battery performance such as the cycle characteristics, and other troubles become unlikely to occur.

The present inventors have further conceived of forming an oxide layer containing SiO₂ between the thin film negative electrode active material layer and the ion-permeable resin layer, by a vapor phase method. This further improves the adhesion between the thin film negative electrode active material layer and ion-permeable resin layer and allows the effect of the ion-permeable resin layer to be exerted for a longer period of time. It should be noted that if the oxide layer is formed in a liquid phase, the smoothness of the surface of the oxide layer is increased, and the adhesion between the oxide layer and ion-permeable resin layer is reduced.

The present inventors have completed the preset invention on the basis of these findings.

The lithium ion secondary battery of the present invention contains an alloy-based negative electrode active material and is excellent in battery performance such as cycle characteristics, output characteristics and the like. Despite containing an alloy-based negative electrode active material, the lithium ion secondary battery of the present invention exhibits less deterioration of the cycle characteristics and has a long service life. As such, the lithium ion secondary battery of the present invention is suitably applicable not only as a power source for various portable electronic devices currently available but also as a power source for multi-functioned electronic devices with large power consumption.

The lithium ion secondary battery of the present invention comprises a positive electrode, a negative electrode, a separator, and an ion-permeable resin layer. The negative electrode includes a negative electrode current collector, and a thin film negative electrode active material layer containing an alloy-based negative electrode active material. The ion-permeable resin layer coats at least part of the surface of the thin film negative electrode active material layer.

FIG. 1 is a longitudinal sectional view schematically showing a configuration of a flat lithium ion secondary battery 1 according to one embodiment of the present invention. The lithium ion secondary battery 1 includes a stacked electrode assembly formed by stacking a positive electrode 11 and a negative electrode 12 having an ion-permeable resin layer 13 formed on the surface thereof, with a separator 14 interposed between these electrodes.

The lithium ion secondary battery 1 further includes a positive electrode lead 15 connected to a positive electrode current collector 11a, a negative electrode lead 16 connected to a negative electrode current collector 12a, a gasket 17 sealing each of openings 18a and 18b of a housing case 18, and the housing case 18 for housing the stacked electrode assembly and a non-aqueous electrolyte, and the non-aqueous electrolyte (not shown).

The positive electrode 11 includes the positive electrode current collector 11a and a positive electrode active material layer 11b.

For the positive electrode current collector 11a, a positive electrode current collector commonly used in the field of lithium ion secondary batteries may be used, examples of which include a conductive substrate such as a porous conductive substrate and a non-porous conducive substrate. The conductive substrate may be made of a metal material such as stainless steel, titanium, aluminum, and aluminum alloy; and a conductive resin. Examples of the porous conductive substrate include a mesh, a net, a punched sheet, a lath, a porous body, a foam, and a nonwoven fabric. Examples of the non-porous conductive substrate include a foil, a sheet, and a film. The thickness of the conductive substrate is usually 1 to 500 μm, preferably 1 to 50 μm, more preferably 10 to 40 μm, and particularly preferably 10 to 30 μm.

The positive electrode active material layer 11b is provided on one surface of the positive electrode current collector 11a in the thickness direction thereof in this embodiment, but not limited thereto, and may be provided on both surfaces thereof. The positive electrode active material layer 11b contains a positive electrode active material. The positive electrode active material layer 11b may contain a conductive agent, a binder, and the like in addition to the positive electrode active material.

For the positive electrode active material, any positive electrode active material may be used without any particular limitation as long as it is capable of absorbing and desorbing lithium ions, but a lithium-containing composite metal oxide, an olivine-type lithium phosphate, and the like are preferably used.

The lithium-containing composite metal oxide is a metal oxide containing lithium and a transition metal element, or alternatively a metal oxide in which part of the transition metal element in the foregoing metal oxide is substituted by a different element. Examples of the transition metal element include Sc, Y, Mn, Fe, Co, Ni, Cu, and Cr, among which Mn, Co, Ni, and the like are preferred. Examples of the different element include Na, Mg, Zn, Al, Pb, Sb, and B, among which Mg, Al, and the like are preferred. These transition metal elements may be used alone or in combination of two or more, and these different elements may be used alone or in combination of two or more.

Examples of the lithium-containing composite metal oxide include Li₁CoO₂, Li₁NiO₂, Li₁MnO₂, Li₁Mn₂O₄, and Li₁Mn₂₋ₘMnO₄, where M is at least one element selected from the group consisting of Na, Mg, Sc, Y, Mn, Fe, Co, Ni, Cu, Zn, Al, Cr, Pb, Sb, and B; 0<1≦1.2, m=0 to 0.9, and n=2.0 to 2.3. The value “1” representing the molar ratio of lithium is a value upon production of the lithium-containing composite metal oxide and increases and decreases during charge and discharge.

Preferred among these is LiᵢCOₘM₁₋ₘOₙ, where M, l, m and n are the same as above. Examples of the olivine-type lithium phosphate include LiXPO₄, and Li₂XPO₄F, where X is at least one selected from the group consisting of Co, Ni, Mn, and Fe. These positive electrode active materials may be used alone or in combination of two or more.

For the conductive agent, a conductive agent commonly used in the field of lithium ion secondary batteries may be used, examples of which include graphites such as natural graphite and artificial graphite; carbon blacks such as acetylene black, Ketjen black, channel black, furnace black, lampblack, and thermal black; conductive fibers such as carbon fibers and metal fibers; powders of metal such as aluminum; conductive whiskers such as zinc oxide whisker and potassium titanate whisker; conductive metal oxides such as titanium oxide; organic conductive materials such as phenylene derivatives; and fluorinated carbons. These conductive agents may be used alone or in combination of two or more.

For the binder, a binder commonly used in the field of lithium ion secondary batteries may be used, examples of which include polyvinylidene fluoride, polytetrafluoroethylene, polyethylene, polypropylene, aramid resin, polyamide, polyimide, polyamide-imide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyether, polyether sulfone, hexafluoropropylene, styrene-butadiene rubber, modified acrylic rubber, carboxymethyl cellulose and the like.

Alternatively, for the binder, a copolymer containing two or more monomer compounds may be used. Examples of the monomer compound include tetrafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, hexadiene and the like. These binders may be used alone or in combination of two or more.

The positive electrode active material layer 11b may be formed by, for example, applying a positive electrode material mixture slurry onto the positive electrode current collector 11a, drying the slurry, followed by rolling. The positive electrode material mixture slurry may be prepared by dissolving or dispersing the positive electrode active material, and, as needed, a conductive agent, a binder, and the like in an organic solvent. For the organic solvent, dimethylformamide, dimethylacetamide, methylformamide, N-methyl-2-pyrrolidone, dimethylamine, acetone, cyclohexanone, and the like may be used.

The negative electrode 12 includes the negative electrode current collector 12a and a thin film negative electrode active material layer 12b.

For the negative electrode current collector 12a, a negative electrode current collector commonly used in the lithium ion secondary batteries may be used, examples of which include a conductive substrate such as a non-porous conducive substrate. The conductive substrate may be made of a metal material such as stainless steel, titanium, nickel, copper, copper alloy and the like. Examples of the non-porous conductive substrate include a foil, a sheet, and a film. The thickness of the conductive substrate is usually 1 to 500 μm, preferably 1 to 50 μm, more preferably 10 to 40 μm, and particularly preferably 10 to 30 μm.

The thin film negative electrode active material layer 12b is provided on one surface of the negative electrode current collector 12a in the thickness direction thereof in this embodiment, but not limited thereto, and may be provided on both surfaces thereof. The thin film negative electrode active material layer 12b is formed by a vapor phase method. The thin film negative electrode active material layer 12b contains an alloy-based negative electrode active material. The thin film negative electrode active material layer 12b may, as long as the characteristics thereof are not impaired, contain a known negative electrode active material other than the alloy-based negative electrode active material, an additive, and the like in addition to the alloy-based negative electrode active material. More preferably, the thin film negative electrode active material layer 12b comprises an alloy-based negative electrode active material in an amorphous or low crystalline state.

Since the thin film negative electrode active material layer 12b is formed by a vapor phase method, the surface thereof has an adequate surface roughness. This improves the adhesion between the thin film negative electrode active material layer 12b and the ion-permeable resin layer 13. Consequently, even when the alloy-based negative electrode active material contained in the thin film negative electrode active material layer 12b undergoes repeated changes in volume, the separation of the ion-permeable resin layer 13 from the thin film negative electrode active material layer 12b can be prevented. As a result, the effect of the ion-permeable resin layer 13 to protect the newly created surfaces is exerted for a long period of time.

The thickness of the thin film negative electrode active material layer 12b is usually 1 to several tens μm, preferably 1 to 20 μm, and more preferably 3 to 15 μm. When the thickness of the thin film negative electrode active material layer 12b is within the foregoing range, even when cracks occur in the alloy-based negative electrode active material particles to create newly created surfaces inside the thin film negative electrode active material layer 12b, most of the newly created surfaces appear on the surface or a vicinity of the surface of the thin film negative electrode active material layer 12b. This allows the newly created surfaces to be more effectively protected by the ion-permeable resin layer 13 and thereby prevents the newly created surfaces from coming in contact with the non-aqueous electrolyte.

As such, the side reaction between the newly created surfaces and the non-aqueous electrolyte is inhibited, and therefore, the generation of by-products is considerably suppressed, the by-products possibly being a cause of a shortened life of the negative electrode 12, a deformation of the lithium ion secondary battery 1, a deterioration of the battery performance of the lithium ion secondary battery 1, and the like. As a result, the advantages of the alloy-based negative electrode active material (i.e., high capacity and high energy density) are exerted sufficiently, and the lithium ion secondary battery 1 with high capacity and high output power being excellent in cycle characteristics and having a long service life can be provided.

The alloy-based negative electrode active material is a material capable of, under negative electrode potential, absorbing lithium by alloying with lithium during charge and desorbing lithium during discharge. As the alloy-based negative electrode active material, any material may be used without any particular limitation, but for example a silicon-based active material, a tin-based active material, and the like are preferably used.

Examples of the silicon-based active material include silicon, a silicon compound, a partial substitution product of these, and a solid solution of these. Examples of the silicon compound include a silicon oxide, a silicon carbide, a silicon nitride, and a silicon alloy. Examples of the silicon oxide include silicon oxide represented by SiOₐ, where 0.05<a<1.95. Examples of the silicon carbide include silicon carbide represented by SiC_{b}, where 0<b<1. Examples of the silicon nitride include silicon nitride represented by SiN_{c}, where 0<c<4/3.

The silicon alloy is an alloy of silicon and a different element A. The different element A is at least one element selected from the group consisting of Fe, Co, Sb, Bi, Pb, Ni, Cu, Zn, Ge, In, Sn, and Ti. The partial substitution product is a compound in which part of silicon in the silicon and the silicon compound is substituted by a different element B. The different element B is at least one element selected from the group consisting of B, Mg, Ni, Ti, Mo, Co, Ca, Cr, Cu, Fe, Mn, Nb, Ta, V, W, Zn, C, N, and Sn. Among these examples of the silicon-based material, silicon and a silicon oxide are preferred.

Examples of the tin-based active material include tin, a tin oxide, a tin nitride, a tin alloy, a tin compound, and a solid solution of these. Examples of the tin oxide include tin oxide represented by SnO_{d}, where 0<d<2, and tin dioxide (SnO₂). Examples of the tin alloy include Ni—Sn alloy, Mg—Sn alloy, Fe—Sn alloy, Cu—Sn alloy, and Ti—Sn alloy. Examples of the tin compound include SnSiO₃, Ni₂Sn₄, and Mg₂Sn. Among these examples of the tin-based active material, tin and a tin oxide are preferred.

Among the above-listed examples of the alloy-based negative electrode active material, preferred are silicon, a silicon oxide, tin, and a tin oxide; more preferred are silicon and a silicon oxide; and particularly preferred is a silicon oxide.

These alloy-based negative electrode active materials may be used alone or in combination of two or more.

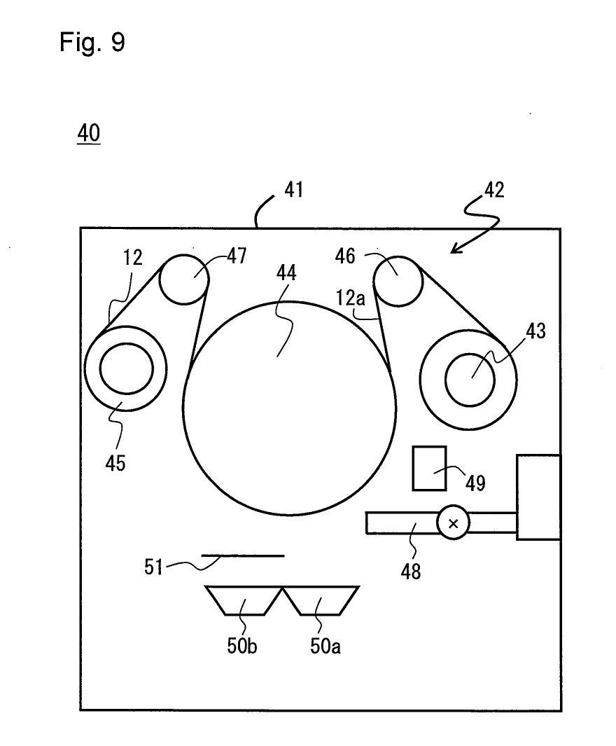

The thin film negative electrode active material layer 12b may be formed on the negative electrode current collector 12a by a vapor phase method. Examples of the vapor phase method include vacuum vapor deposition, sputtering, ion plating, laser ablation, chemical vapor deposition (CVD), plasma chemical vapor deposition, and flame spraying. Preferred among these is vacuum vapor deposition. For example, a vacuum vapor deposition apparatus 40 as shown in FIG. 9 may be used to form the thin film negative electrode active material layer 12b.

In this embodiment, it is preferable that at least part of the surface of the thin film negative electrode active material layer 12b has asperities or cracks. It should be noted that the asperities and cracks are different from the cracks formed on the thin film negative electrode active material layer 12b during charge and discharge. The asperities or cracks are formed on the thin film negative electrode active material layer 12b prior to the formation of the ion-permeable resin layer 13 on the thin film negative electrode active material layer 12b.

Forming the asperities or cracks on the surface of the thin film negative electrode active material layer 12b further improves the adhesion between the thin film negative electrode active material layer 12b and the ion-permeable resin layer 13. As a result, for example, a local separation of the ion-permeable resin layer 13 from the thin film negative electrode active material layer 12b is further prevented. As such, the battery characteristics such as cycle characteristics, output characteristics and the like are maintained at almost the same level as those at the beginning of use, substantially throughout the service life of the lithium ion secondary battery 1.

In addition, forming the asperities and/or cracks further presumably prevents the occurrence of cracks in the thin film negative electrode active material layer 12b associated with charge and discharge. As a result, the creation of newly created surfaces is inhibited, making the side reaction due to the contact of the newly created surfaces with the non-aqueous electrolyte more unlikely to occur. This further prevents the deterioration in the battery characteristics of the lithium ion secondary battery 1. As such, even when subjected to repeated charge/discharge cycles, the battery lasts for almost the same period of time per charge as that at the beginning of use, and exhibits a high output voltage.

The dimensions of each recess of the asperities and each of the cracks on the surface the thin film negative electrode active material layer 12b are not particularly limited, but preferably are a length of 0.1 to 20 μm, a width of 0.1 to 5 μm, and a depth of 0.1 to 20 μm. When at least one of the length, width, and depth are within the foregoing ranges, the anchor effect is exerted, and the adhesion between the thin film negative electrode active material layer 12b and the ion-permeable resin layer 13 is reliably improved. In addition, the occurrence of cracks and the creation of newly created surfaces associated with charge and discharge are prevented.

The asperities or cracks can be formed on the surface of the thin film negative electrode active material layer 12b by, for example, a method of forming a thin film of alloy-based negative electrode active material by deposition dividedly several times (hereinafter referred to as a “deposition method”), a method of adjusting the surface roughness (Ra) of the surface of the negative electrode current collector 12a (hereinafter referred to as a “surface adjusting method”), and the like. According to the deposition method, a thin film A of alloy-based negative electrode active material having a thickness smaller than the normal one is formed on the surface of the negative electrode current collector 12a, and then on the surface of the thin film A, a thin film of alloy-based negative electrode active material is partially formed by deposition, whereby the asperities or cracks are formed.

According to the surface adjusting method also, the asperities or cracks can be formed efficiently on the surface of the thin film negative electrode active material layer 12b. The surface adjusting method is effective for the following reason. The thin film negative electrode active material layer 12b is formed by a vapor phase method, and a thin film formed by such a vapor phase method tends to have an almost uniform thickness. Therefore, by forming the thin film negative electrode active material layer 12b by a vapor phase method after the surface roughness of the negative electrode current collector 12a is adjusted, the adjusted surface roughness of the negative electrode current collector 12a will be reproduced as it is on the surface of the thin film negative electrode active material layer 12b.

As the adjusting method of the surface roughness of the negative electrode current collector 12a, any known method may be used, examples of which include mechanical grinding, chemical etching, electrochemical etching, and grinding with abrasives. Alternatively, the surface roughness of the negative electrode current collector 12a may be adjusted by forming fine asperities on the surface of the negative electrode current collector 12a by plating and the like.

Prior to the formation of the ion-permeable resin layer 13 on the surface of the thin film negative electrode active material layer 12b, lithium may be vapor deposited in an amount equivalent to an irreversible capacity onto the thin film negative electrode active material layer 12b. The irreversible capacity is the amount of lithium that is stored in the thin film negative electrode active material layer 12b during the initial charge and discharge and will not be released from the thin film negative electrode active material layer 12b.

The ion-permeable resin layer 13 is formed at least part of the surface of the thin film negative electrode active material layer 12b and is interposed between the thin film negative electrode active material layer 12b and the separator 14. By virtue of the ion-permeable resin layer 13, even when newly created surfaces appear in the thin film negative electrode active material layer 12b in association with charge and discharge, the contact of the newly created surfaces with the non-aqueous electrolyte can be prevented. The ion-permeable resin layer 13, while being in close contact with the thin film negative electrode active material layer 12b, exerts its effect effectively.

The ion-permeable resin layer 13 has lithium ion permeability. As such, the ion-permeable resin layer 13 will not act an inhibitor of the battery reaction in the lithium ion secondary battery 1 and will not cause the battery performance such as output characteristics of the lithium ion secondary battery 1 to deteriorate. The ion-permeable resin layer 13 may have ion conductivity.

The ion-permeable resin layer 13 contains a polymer and may contain a supporting salt as needed.

Examples of the polymer contained in the ion-permeable resin layer 13 include fluorocarbon resin, polyacrylonitrile, polyethylene oxide, and polypropylene oxide. Examples of the fluorocarbon resin include polyvinylidene fluoride, polytetrafluoroethylene, a copolymer of vinylidene fluoride and hexafluoropropylene, and a copolymer of vinylidene fluoride and tetrafluoroethylene. These polymers may be used alone or in combination of two or more.

The resin layer comprising a polymer as listed above, without the need of adding a supporting salt, swells when it comes in contact with the non-aqueous electrolyte in the lithium ion secondary battery 1 in an assembled state, to serve as the ion-permeable resin layer 13. When a polymer as listed above is used, the reduction in the adhesion between the thin film negative electrode active material layer 12b and the ion-permeable resin layer 13 can be sufficiently prevented.

When the ion-permeable resin layer 13 additionally contains a supporting salt, the ion-permeable resin layer 13 has ion conductivity. Provided that the supporting salt is a lithium salt, the ion-permeable resin layer 13 has lithium ion conductivity. Examples of the supporting salt includes LiClO₄, LiBF₄, LiPF₆, LiAlCl₄, LiSbF₆, LiSCN, LiCF₃SO₃, LiCF₃CO₂, LiAsF₆/LiB₁₀Cl₁₀, lithium lower aliphatic carboxylate, LiCl, LiBr, LiI, LiBCl₄, boric acid salts, and imide salts. These supporting salts may be used alone or in combination of two or more.

The thickness of the ion-permeable resin layer 13 is preferably 0.1 to 20 μm, and more preferably 1 to 10 μm. When the thickness of the ion-permeable resin layer 13 is less than 0.1 μm, the ion-permeable resin layer 13 may fail to sufficiently prevent the contact of the newly created surfaces with the non-aqueous electrolyte. When the thickness of the ion-permeable resin layer 13 exceeds 20 μm, the ion permeability of the ion-permeable resin layer 13 is reduced, and the output characteristics, cycle characteristics, storage characteristics of the lithium ion secondary battery 1 may deteriorate.

The ion-permeable resin layer 13 may be formed by, for example, applying a polymer solution to the surface of the thin film electrode active material layer 12b and drying the polymer solution. The polymer solution may be formed by, for example, dissolving or dispersing a polymer and, as needed, a supporting salt, those as listed above, in an organic solvent. For the organic solvent, dimethylformamide, dimethylacetamide, methylformamide, N-methyl-2-pyrrolidone, dimethylamine, acetone, cyclohexanone, and the like may be used.

The polymer content in the polymer solution is preferably 1 to 10% by weight of the total amount the polymer solution. When the polymer content is within the foregoing range, the ion-permeable resin layer 13 can have an entirely uniform organization and exhibit a good adhesion with the thin film negative electrode active material layer 12b. Particularly when the asperities or cracks are formed on the surface of the thin film negative electrode active material layer 12b beforehand, the polymer enters the asperities or cracks. This allows the anchor effect due to the asperities or cracks to be exerted sufficiently, thus improving the adhesion between the thin film negative electrode active material layer 12b and the ion-permeable resin layer 13.

The polymer solution preferably has a viscosity at 80° C. of 0.1 to 10 cps. The viscosity herein is a viscosity measured at 80° C. with a viscosity/viscoelasticity meter (trade name: RheoStress 600, available from EKO Instruments Co., Ltd.). When the viscosity of the polymer solution is within the foregoing range, the polymer solution readily enters the asperities or cracks on the surface of thin film negative electrode active material layer 12b. This further improves the adhesion between the thin film negative electrode active material layer 12b and the ion-permeable resin layer 13.

The foregoing range of the viscosity of the polymer solution is particularly advantageous in forming the permeable resin layer 13 and permeable resin layers 28 and 28a described later on the surface of thin film negative electrode active material layers 23 and 26 described later. The thin film negative electrode active material layers 23 and 26 include a plurality of columns 24 and 27, respectively. A gap is present between a pair of adjacent columns 24 as well as between a pair of adjacent columns 27. The polymer solution having a viscosity within the foregoing range smoothly enters these gaps. This allows the anchor effect due to the plurality of columns 24 and 27 to be exerted remarkably, thus further improving the adhesion of the ion-permeable resin layers 13, 28 and 28a to the thin film negative electrode active material layers 23 and 26.

When the viscosity at 80° C. of the polymer solution is less than 0.1 cps, it may be difficult to form the ion-permeable resin layer 13. When the viscosity at 80° C. of the polymer solution exceeds 10 cps, the polymer solution may not sufficiently enter the asperities or cracks on the surface of the thin film negative electrode active material layer 12b. As a result, the effect of further improving the adhesion between the thin film negative electrode active material layer 12b and the ion-permeable resin layer 13 may not be exerted sufficiently. Moreover, the ion permeability of the ion-permeable resin layer 13 may be reduced.

The ion-permeable resin layer 13 having a thickness of 0.1 to 20 μm can be obtained by applying the polymer solution having a viscosity at 80° C. within the foregoing range onto the surface of the thin film negative electrode active material layer 23 in an amount of 0.1 mg to 0.8 mg per cm² of the surface area thereof.

The polymer solution can be applied onto the surface of the thin film negative electrode active material layer 12b by any known method. Examples of the method include screen printing, die coating, comma coating, roller coating, bar coating, gravure coating, curtain coating, spray coating, air knife coating, reverse coating, and dip and squeeze coating. The thickness of the ion-permeable resin layer 13 can be adjusted by, for example, changing the amount of the polymer solution applied onto the surface of the thin film negative electrode active material layer 12b, and other conditions.

The separator 14 is interposed between the positive electrode 11 and the negative electrode 12, and at least part of the surface thereof in the negative electrode side is in contact with the surface of the ion-permeable resin layer 13. For the separator 14, a porous sheet having predetermined properties such as ion permeability, mechanical strength, and insulating property may be used. The porous sheet has pores. Examples of the porous sheet include a microporous film, woven fabric, and nonwoven fabric. The microporous film may be any of a single-layer film and a multi-layer film (composite film). The single-layer film is made of one type of material. The multi-layer film (composite film) is a stack of single-layer films. The single-layer films may be made of one type of material or may be made of different materials. Two or more of the microporous film, woven fabric, nonwoven fabric, and the like may be used in combination.

For the material of the separator 14, various resin materials may be used, but polyolefin such as polyethylene and polypropylene is preferred in view of the durability, the shutdown function, the safety of the battery, and the like. Here, the shutdown function is a function that works when the battery temperature is abnormally elevated in such a way that the pores of the separator 14 are closed to interrupt the migration of ions, thereby to shut down the battery reaction.

The thickness of the separator 14 is generally 10 to 300 μm, but is preferably 10 to 40 μm, more preferably 10 to 30 μm, and more preferably 10 to 25 μm. The porosity of the separator 14 is preferably 30 to 70%, and more preferably 35 to 60%. Here, the porosity is a ratio, expressed as a percentage, of the total volume of pores present in the separator 14 to the volume of the separator 14.

The separator 14 is impregnated with a non-aqueous electrolyte with lithium ion conductivity. Examples of the non-aqueous electrolyte include liquid non-aqueous electrolyte and solid non-aqueous electrolyte.

The liquid non-aqueous electrolyte includes a support salt and a non-aqueous solvent, and further includes, as needed, various additives. The support salt usually dissolves in a non-aqueous solvent. The liquid non-aqueous electrolyte is impregnated, for example, into the separator.

For the solute, a solute commonly used in this field may be used, examples of which include LiClO₄, LiBF₄, LiPF₆, LiAlCl₄, LiSbF₆, LiSCN, LiCF₃SO₃, LiCF₃CO₂, LiAsF₆, LiBₙCl₁₀, lithium lower aliphatic carboxylate, LiCl, LiBr, LiI, LiBCl₄, boric acid salts, and imide salts.

Examples of the boric acid salts include lithium bis(1,2-benzendioleate(2-)-O,O′) borate, lithium bis(2,3-naphthalenedioleate(2-)-O,O′) borate, lithium bis(2,2′-biphenyldioleate(2-)-O,O′) borate, and lithium bis(5-fluoro-2-oleate-1-benzenesulfonate-O,O′) borate.

Examples of the imide salts include lithium bis(trifluoromethanesulfonyl)imide ((CF₃SO₂)₂NLi), lithium (trifluoromethanesulfonyl) (nonafluorobutanesulfonyl)imide (LiN(CF₃SO₂) (C₄F₉SO₂)), and lithium bis(pentafluoroethanesulfonyl)imide ((C₂F₅SO₂)₂NLi). These support salts may be used alone or in combination of two or more. The amount of the support salt to be dissolved in the non-aqueous solvent is preferably 0.5 to 2 mol/liter.

For the non-aqueous solvent, a non-aqueous solvent commonly used in the field of lithium ion secondary batteries may be used, examples of which include cyclic carbonic acid ester, chain carbonic acid ester, and cyclic carboxylic acid ester. Examples of the cyclic carbonic acid ester include propylene carbonate, ethylene carbonate, and the like. Examples of the chain carbonic acid ester include diethyl carbonate, ethyl methyl carbonate, dimethyl carbonate, and the like. Examples of the cyclic carboxylic acid ester include γ-butyrolactone, γ-valerolactone, and the like. These non-aqueous solvents may be used alone or in combination of two or more.

Examples of the additive include additive A, additive B and the like.

Additive A decomposes on the negative electrode to form a coating film excellent in lithium ion conductivity, improving the charge-discharge efficiency. Examples of additive A include vinylene carbonate, 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinylethylene carbonate, and divinylethylene carbonate. Among these, vinylene carbonate, vinylethylene carbonate, and divinylethylene carbonate are preferred. In the above-listed compounds, part of hydrogen atoms may be substituted by fluorine atoms. These additives A may be used alone or in combination of two or more.

Additive B decomposes during overcharge of the battery to form a coating film on the surface of the electrode, to inactivate the battery. Examples of additive B include a benzene derivative. The benzene derivative is a benzene compound having a phenyl group and a cyclic compound group adjacent to the phenyl group. Examples of the cyclic compound group include a phenyl group, a cyclic ether group, a cyclic ester group, a cycloalkyl group, and a phenoxy group. Examples of the benzene derivative include cyclohexyl benzene, biphenyl, and diphenyl ether. These additives B may be used alone or in combination of two or more. The amount of additive B used is preferably less than or equal to 10 parts by volume per 100 parts by volume of the non-aqueous solvent.

The gelled non-aqueous electrolyte includes a liquid non-aqueous electrolyte and a polymer material for retaining the liquid non-aqueous electrolyte. The polymer material turns the liquid non-aqueous electrolyte into gel. For the polymer material, a polymer material commonly used in the field of lithium ion secondary batteries may be used, examples of which include polyvinylidene fluoride, polyacrylonitrile, polyethylene oxide, polyvinyl chloride, and polyacrylate.

This embodiment uses the separator 14 and the non-aqueous electrolyte, but not limited thereto, and may use a solid electrolyte. Using a solid electrolyte enables further reductions in thickness and size of the lithium ion secondary battery 1. Further, using a solid electrolyte eliminates a risk of electrolyte leakage, enabling further improvements in safety and reliability of the lithium ion secondary battery 1. The solid electrolyte is classified into an inorganic solid electrolyte and an organic solid electrolyte, among which an organic solid electrolyte is preferred. Using an organic solid electrolyte, particularly a polymer electrolyte, can provide a flexible thin battery.

Examples of the inorganic solid electrolyte include a sulfide-based inorganic solid electrolyte, an oxide-based inorganic solid electrolyte, and other lithium-based inorganic solid electrolyte. Examples of the sulfide-based inorganic solid electrolyte include (Li₃PO₄)ₓ-(Li₂S)_{y}—(SiS₂)_{z} glass, (Li₂S)ₓ—(SiS₂)_{y}, (Li₂S)ₓ—(P₂S₅)_{y}, Li₂S—P₂S₅, and thio-LISICON.

Examples of the oxide-based inorganic solid electrolyte include NASICON electrolyte such as LiTi₂(PO₄)₃, LiZr₂(PO₄)₃, and LiGe₂(PO₄)₃; and perovskite electrolyte such as (La_{0.5+x}Li_{0.5-3x})TiO₃. Examples of the other lithium-based inorganic solid electrolyte include LiPON, LiNbO₃, LiTaO₃, Li₃PO₄, LiPO₄₋ₓNₓ, where 0<x≦1, LiN, LiI, and LISICON. As the solid electrolyte, glass ceramics obtained by crystallization of the inorganic solid electrolyte may also be used.

The electrolyte layer comprising the inorganic solid electrolyte may be formed by vapor deposition, sputtering, laser abrasion, gas deposition, aerosol deposition, and other methods.

Examples of the organic solid electrolyte include ion conductive polymers, polymer electrolytes and the like. Examples of the ion conductive polymers include polyether with low phase transition temperature (Tg), amorphous vinylidene fluoride copolymer, and a blend of different polymers.

For the polymer electrolyte, a polymer electrolyte commonly used in the field of solid electrolyte batteries may be used, among examples of which, preferred is a polymer electrolyte (1) containing a polymer at least having an electron-donating element in its skeleton, and a lithium salt. The electron-donating element generates in the polymer electrolyte (1) a strong interaction equivalent to the interaction between lithium ions and anions. Due to the action of the electron-donating electrolyte, in the polymer electrolyte (1), part of lithium salt is dissociated into lithium ions and anions, and the lithium ions and anions are present in a dissolved state. The dissociated lithium ions are coordinated to the electron-donating element and move through the polymer structure or on the polymer chain. It is considered that the lithium ions can move through the polymer mainly by the segmental motion of polymer chain. Because of this, an excellent ion conductivity is exhibited.

The polymer having an electron-donating element in its skeleton is used as a matrix polymer. Examples of the polymer having an electron-donating element in its skeleton include a polymer having an electron-donating oxygen in either one or both of its main chain and side chain. Examples of the electron-donating oxygen include ether oxygen and ester oxygen. Examples of the matrix polymer include polyethylene oxide, polypropylene oxide, a copolymer of ethylene oxide and propylene oxide, a polymer containing an ethylene oxide unit or a propylene oxide unit, polycarbonate and the like.

For the lithium salt, the lithium salts listed above as examples of the non-aqueous electrolyte may be used.

The description of the lithium ion secondary battery 1 is resumed.

One end of the positive electrode lead 15 is connected to the positive electrode current collector 11a, and the other end thereof is guided from the opening 18a of the housing case 18 to outside the lithium ion secondary battery 1. One end of the negative electrode lead 16 is connected to the negative electrode current collector 12a, and the other end thereof is guided from the opening 18b of the housing case 18 to outside the lithium ion secondary battery 1. For the positive electrode lead 15 and the negative electrode lead 16, a lead commonly used in the field of lithium ion secondary batteries may be used. For example, for the positive electrode lead 15, an aluminum lead and the like may be used; and for the negative electrode lead 16, a nickel lead, a copper lead, and the like may be used.

The openings 18a and 18b of the housing case 18 are each sealed with the gasket 17. The gasket 17 is formed of, for example, various resin materials. For the housing case 18, a housing case commonly used in the field of lithium ion secondary batteries, for example, those made of metal material, laminate film, and synthetic resin may be used. In the case of using the housing case 18 made of laminate film, the openings 18a and 18b may be directly sealed without the gasket 17 by welding and other methods.

The lithium ion secondary battery 1 can be produced, for example, in the following manner. One end of the positive electrode lead 15 is connected to a surface of the positive electrode current collector 11a on which the positive electrode active material layer 11b is not formed. One end of the negative electrode lead 16 is connected to a surface of the negative electrode current collector 12a on which the negative electrode active material layer 12b is not formed. Next, the positive electrode 11 and the negative electrode 12 are stacked with the separator 14 interposed therebetween to form an electrode assembly. Here, the positive electrode 11 and the negative electrode 12 are arranged such that the positive electrode active material layer 11b and the thin film negative electrode active material layer 12b face each other with the separator 14 interposed therebetween.

The electrode assembly thus formed is inserted into the housing case 18 together with the non-aqueous electrolyte, and the other ends of the positive electrode leads 15 and negative electrode leads 16 are guided outside the housing case 18. Next, the openings 18a and 18b are each sealed by welding with the gasket 17 interposed, while the pressure in the interior of the housing case 18 is reduced to vacuum. In such a manner, the lithium ion secondary battery 1 is produced.

A different type of thin film negative electrode active material layer includes a plurality of columns. The columns contain an alloy-based negative electrode active material. The columns are spaced apart from each other and extend externally from the surface of the negative electrode current collector. A gap is present between a pair of columns adjacent to each other. In the thin film negative electrode active material layer including a plurality of columns, due to the presence of the gaps between the columns, the anchor effect of the thin film negative electrode active material layer is remarkably improved. This further improves the adhesion between the thin film negative electrode active material layer and the ion-permeable resin layer.

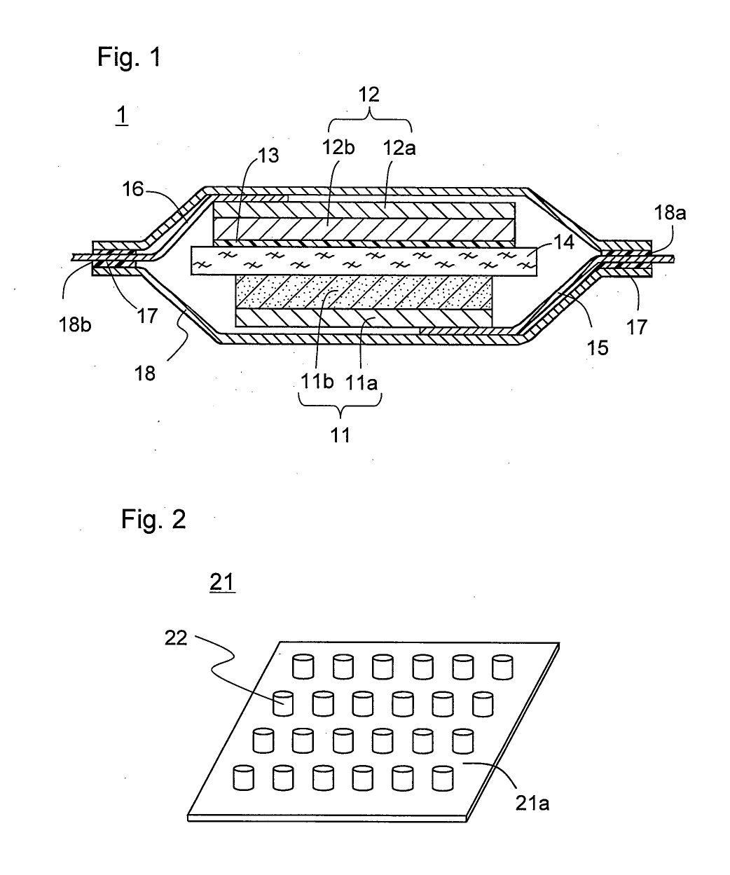

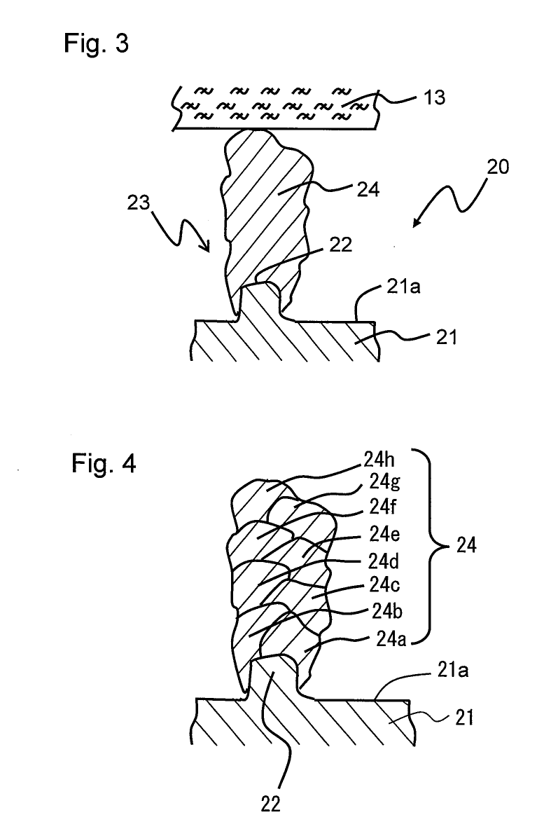

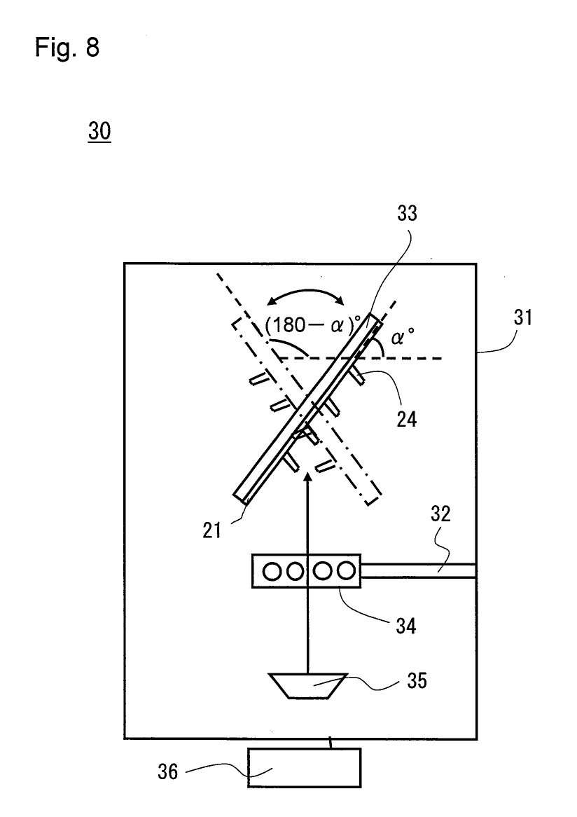

In the present invention, a different type of negative electrode including the above-described different type of thin film negative electrode active material layer may be used. FIG. 2 is a perspective view schematically showing a configuration of a negative electrode current collector 21. FIG. 3 is a longitudinal sectional view schematically showing a configuration of a different type of negative electrode 20 including the negative electrode current collector 21 shown in FIG. 2. FIG. 4 is a longitudinal sectional view schematically showing a configuration of a column 24 included in a thin film negative electrode active material layer 23 shown in FIG. 3. FIG. 8 is a side view schematically showing a configuration of an electron beam vapor deposition apparatus 30 for forming the thin film negative electrode active material layer 23.

The negative electrode 20 includes the negative electrode current collector 21 and the thin film electrode active material layer 23.

The negative electrode current collector 21, as shown in FIG. 2, includes a plurality of projections 22 provided on one surface thereof in its thickness direction in this embodiment, but not limited thereto, and may include a plurality of projections 22 provided on both surfaces thereof. The negative electrode current collector 21 has the same configuration as the negative electrode current collector 12a except that it includes the projections 22. The projections 22 extend externally from a surface 21a of the negative electrode current collector 21 in its thickness direction (hereinafter simply referred to as a “surface 21a”).

The height of the projections 22 is not particularly limited, but preferably is 3 to 10 μm in terms of an average height. The height of each of the projections 22 is defined on the cross section of the projection 22 in the thickness direction of the negative electrode current collector 21. The cross section of the projection 22 is a cross section including the uppermost end of the projection 22 in its extending direction. On the cross section of the projection 22, the height of the projection 22 is the length of a perpendicular drawn from the uppermost end of the projection 22 in its extending direction to the surface 21a. The average height of the projections 22 is determined as an average of the heights of one hundred projections 22 obtained, for example, by observing the cross sections of the projections 22 under a scanning electron microscope (SEM) and measuring and averaging the heights.

The cross-sectional diameter of the projections 22 is not particularly limited, but preferably is 1 to 50 μm. The cross-sectional diameter of each of the projection 22 is the width of the projection 22 in the parallel direction to the surface 21a on the cross section of the projection 22 used for measuring the height of the projection 22. The cross-sectional diameter of the projections 22 is also determined as an average of the widths of one hundred projections 22 obtained, similarly to the height of the projections 22, by observing the cross sections, and measuring and averaging the widths.

It is not necessary that all of the projections 22 have the same height or the same cross-sectional diameter.

The shape of the projection 22 is a circle in this embodiment. The shape of the projection 22 is a shape of the projection 22 on the orthographic view from vertically above of the negative electrode current collector 21. The shape of the projection 22 is not limited to a circle and may be a polygon, an ellipse, a parallelogram, a trapezoid, a rhomboid, and the like. In consideration of production costs and the like, the polygon is preferably a triangle to an octagon, and more preferably an equilateral triangle to an equilateral octagon. The axis of the projection having a shape of polygon, parallelogram, trapezoid or rhomboid is a virtual line passing through the point of intersection of the diagonals and extending along the normal to the surface 21a. The axis of the projection in the shape of an ellipse is a virtual line passing through the point of intersection of the long axe and the short axe and extending along the normal to the surface 21a.

The projection 22 has an almost flat top surface at the end in the extending direction thereof. This improves the bonding between the projections 22 and the columns 24. Forming the projections 22 such that the flat top surfaces thereof are almost parallel to the surface 21a further improves the bonding between the projections 22 and the columns 24.

The number of the projections 22, the distance between the adjacent projections 22, and the like are not particularly limited, and may be suitably selected according to the size of the projections 22 (e.g., the height, and the cross-sectional diameter), the dimensions of the columns 24 formed on the surfaces of the projections 22, and the like. For example, the number of the projections 22 is about 10,000 to 10,000,000/cm²; and the axis-to-axis distance between a pair of the projections 22 adjacent to each other is preferably 2 μm to 100 μm. The projections 22 are arranged on the surface 21a in a regular pattern or in an irregular pattern. Examples of the regular pattern include a grid pattern, a staggered pattern, and a close-packed pattern.

The projection 22 may have a bump (not shown) formed on its surface. This further improves the bonding between the projections 22 and the columns 24. As a result, a separation of the column 24 from the projection 22, a spread of the separation, and the like can be more reliably prevented. The bump is formed so as to protrude externally from the surface of the projection 22. A plurality of bumps being smaller in dimensions than the projections 22 may be formed. The bumps may be formed on the side surface of the projection 22 so as to protrude in the circumferential direction and/or the growing direction of the projection 22. In the case where the projection 22 has a flat top surface at its end, one or a plurality of bumps smaller than the projection 22 may be formed on the top, and further, one or a plurality of the bumps formed on the top may extend in one direction.

The negative electrode current collector 21 can be produced by using a technique of forming asperities on a metal sheet, for example, a method of using a roller having depressions formed on its surface (hereinafter referred to as a “roller method”), a photo resist method, and the like. For the metal sheet, a metal foil, a metal sheet, a metal plate, and the like may be used. The metal sheet may be made of stainless steel, titanium, nickel, copper, copper alloy, and the like.

According to the roller method, the metal sheet is mechanically pressed using a roller having depressions formed on its surface (hereinafter referred to as a “projection-forming roller”). By doing this, the negative electrode current collector 21 comprising a metal sheet with the projections 22 formed on at least one surface thereof can be produced. The projection-forming roller has, as described above, a plurality of depressions formed on its circumferential surface in a regular pattern. By using such a roller, the projections 22 corresponding to the dimensions of the depressions, the shape of the internal space thereof, and the number and arrangement thereof can be formed.

When two projection-forming rollers are press-fitted with the axes of the two rollers being parallel to each other so that a press fit portion is formed therebetween, and the metal sheet is passed through the press fit portion to be press-molded, a negative electrode current collector comprising a metal sheet with the projections 22 formed on both surfaces thereof in its thickness direction can be produced. When one projection-forming roller and a roller having a smooth surface are press-fitted with the axes of the two rollers being parallel to each other so that a press fit portion is formed therebetween, and the metal sheet is passed through the press fit portion to be press-molded, the negative electrode current collector 21 can be produced. The press fitting pressure of rollers is suitable selected according to the material and thickness of the metal sheet, the shape and dimensions of the projections 22, the setting values of the thickness of the negative electrode current collector obtained after press-molding, and the like.

The projection-forming roller can be produced by forming depressions at predetermined positions on the surface of a ceramic roller. The ceramic roller includes a core roller and a flame sprayed layer. For the core roller, a roller made of iron, stainless steel, or the like may be used. The flame sprayed layer is formed by flame spraying a ceramic material such as chromium oxide on the surface of the core roller. The depressions are then formed on the flame sprayed layer. In forming the depressions, a general laser for machining a ceramic material can be used.

A different type of projection-forming roller includes a core roller, a base layer, and a flame sprayed layer. The core roller is the same as the core roller of the ceramic. The base layer is a resin layer formed on the surface of the core roller and has depressions on its surface. The resin layer is made of a synthetic resin preferably having a high mechanical strength, examples of which include thermosetting resins such as unsaturated polyester, thermosetting polyimide, and epoxy resin; and thermoplastic resins such as polyamide, polyetherketone, polyetheretherketone, and fluorocarbon resin.

The base layer is formed by placing a resin sheet having a plurality of depressions formed on one surface thereof around the core roller and bonding the resin sheet thereto. Here, the resin sheet is placed such that the surface on which the depressions are not formed comes in contact with the surface of the core roller. The flame sprayed layer is formed by flame spraying a ceramic material such as chromic oxide on the base layer surface in conformity with the irregularities on the surface thereof. For this reason, it is preferable to form the depressions on the base layer so as to have dimensions larger than the design dimensions of the projections 22, by an amount corresponding to the thickness of the flame sprayed layer.

Another different type of projection-forming roller includes a core roller and a cemented carbide layer. The core roller is the same as the core roller of the ceramic. The cemented carbide layer is formed on the surface of the core roller and contains cemented carbide such as tungsten carbide. The cemented carbide layer can be formed by thermal fitting or cool fitting. In the thermal fitting, a cylindrical cemented carbide is warmed to expand, and fitted onto the core roller. In the cool fitting, the core roller is cooled to shrink, and inserted into a cylindrical cemented carbide. The depressions are formed on the surface of the cemented carbide layer by, for example, laser machining.

Yet another type of projection-forming roller includes a hard iron-based roller and depressions formed on the surface of the hard iron-based roller. The depressions are formed by, for example, laser machining. The hard iron-based roller is a roller used, for rolling a metal foil. Examples of the hard iron-based roller include rollers made of high-speed steel, forged steel, and the like. The high-speed steel is an iron-based material with metals such as molybdenum, tungsten, and vanadium added thereto and heated to increase the hardness. The forged steel is an iron-based material made by heating a steel ingot, and forging with presses and hummers, or rolling and forging, followed by further heating. The steel ingot is made by casting molten steel using a mold. In place of the steel ingot, a steel slab made of a steel ingot may be used.

In a photoresist method, the negative electrode current collector 21 can be produced by forming a resist pattern on the surface of a metal sheet, and metal-plating the surface of the metal sheet.

In forming the bumps on the surfaces of the projections 22, projection precursors having dimensions larger than the design dimensions of the projections 22 are formed first, and then the surfaces of the projection precursors are etched, whereby the projections 22 having bumps on the surfaces thereof are formed. Thereafter, the surfaces of the projections 22 are plated, whereby the projections 22 having bumps on the surfaces thereof are produced.

The thin film negative electrode active material layer 23 includes a plurality of the columns 24. The columns 24 formed on the surface of the projections 22 extend externally from the negative electrode current collector 21. The columns 24 grow along the normal to the surface 21a of the negative electrode current collector 21 or along a direction inclined from the normal to the surface 21a. A gap is present between a pair of adjacent columns 24, and the columns 24 are formed so as to be spaced apart from each other. The gaps thus formed act to reduce the stress due to expansion and contraction associated with charge and discharge. As a result, the thin film negative electrode active material layer 23 is unlikely to separate from the projections 22, and a deformation of the negative electrode current collector 21 and thus a deformation of the negative electrode 20 are unlikely to occur.

As shown in FIG. 4, the column 24 is preferably formed as a columnar body formed by stacking eight columnar chunks 24a, 24b, 24c, 24d, 24e, 24f, 24g, and 24h. The column 24 is formed as follows. First, the columnar chunk 24a is formed so as to cover the top of the projection 22 and a part of the side surface continued therefrom. Then, the columnar chunk 24b is formed so as to cover the remaining part of the side surface of the projection 22 and a part of the top of the columnar chunk 24a. That is, the columnar chunk 24a is formed at one edge of the projection 22 that includes the top face of the projection 22; and the columnar chunk 24b is partially stacked on the columnar chunk 24a but the remaining portion is formed at the other edge of the projection.

The columnar chunk 24c is formed so as to cover the remaining part of the top face of the columnar chunk 24a and a part of the top face of the columnar chunk 24b. That is, the columnar chunk 24c is formed to be mainly in contact with the columnar chunk 24a. Further, the columnar chunk 24d is formed so as to be mainly in contact with the columnar chunk 24b. By stacking the columnar chunks 24e, 24f, 24g, and 24h alternately in the same manner, the column 24 is formed. The number of stacking of the columnar chunks is not limited to eight, and may be any number of two or more.

The column 24 can be formed by the electron beam vapor deposition apparatus 30 as shown in FIG. 8. In FIG. 8, solid lines are used to illustrate the members in the vapor deposition apparatus 30. The vapor deposition apparatus 30 includes a chamber 31, a first pipe 32, a fixing table 33, a nozzle 34, a target 35, an electron beam generating apparatus (not shown), a power source 36, and a second pipe (not shown).

The chamber 31 is a pressure-tight container and contains the first pipe 32, the fixing table 33, the nozzle 34, the target 35, and the electron beam generating apparatus. One end of the first pipe 32 is connected to the nozzle 34, and the other end extends outside the chamber 31, and is connected to a raw material gas tank or a raw material gas producing apparatus (not shown) via a mass flow controller (not shown). Examples of the raw material gas include oxygen and nitrogen. The first pipe 32 supplies the raw material gas to the nozzle 34.

The fixing table 33 is a rotatably supported board-like member, and the negative electrode current collector 21 can be fixed on one surface of the fixing table 33 in the thickness direction thereof (hereinafter referred to as a “fixing surface”). The fixing table 33 is rotated between the positions shown by the solid line and the position shown by the dot-dash line in FIG. 8. At the position shown by the solid line, the fixing surface of the fixing table 33 faces the nozzle 34 located vertically below the fixing table 33 and the angle between the fixing table 33 and the horizontal line is α°. At the position shown by the dash-dot line, the fixing surface of the fixing table 33 faces the nozzle 34 located vertically below the fixing table 33 and the angle between the fixing table 33 and the horizontal line is (180-α)°. The angle between the fixing table 33 and the horizontal line can be suitably selected according to the dimensions of the column 24 to be formed, and the like.

The nozzle 34 is provided vertically between the fixing table 33 and the target 35 and is connected to one end of the first pipe 32. The raw material gas supplied from the first pipe 32 is discharged from the nozzle 34 into the chamber 31. The target 35 holds an alloy-based negative electrode active material or a raw material thereof. The electron beam generating apparatus irradiates the target 35 with electron beam, so that vapor of the alloy-based negative electrode active material or the raw material thereof is generated.

The power source 36 is provided outside the chamber 31, and applies a voltage to the electron beam generating apparatus. The electron beam generating apparatus then generates electron beam to irradiate the target 35 with the electron beam. The second pipe introduces a gas into the chamber 31, the gas forming the atmosphere therein. An electron beam vapor deposition apparatus having the same configuration as that of the vapor deposition apparatus 30 is commercially available from Ulvac Inc.

In the electron beam vapor deposition apparatus 30, the thin film negative electrode active material layer 23 is formed in the following manner. First, the negative electrode current collector 21 is fixed on the fixing table 33, and oxygen gas is introduced into the chamber 31. In such a state, the alloy-based negative electrode active material or the raw material thereof on the target 35 is irradiated with electron beam and heated to generate vapor therefrom. In this embodiment, silicon is used for the alloy-based negative electrode active material. The vapor generated goes up vertically, and, when passing through near the nozzle 34, is mixed with the raw material gas discharged from the nozzle 34. The resultant mixture gas further goes up vertically to be supplied to the surface of the negative electrode current collector 21 fixed on the fixing table 33, and thus a layer containing silicon and oxygen is formed on the surfaces of the projections 22 (not shown).

When the fixing table 33 is in the position shown by the solid line, the columnar chunks 24a as shown in FIG. 4 are formed on the surfaces of the projections 22. Subsequently, by tilting the fixing table 33 to the position shown by the dash-dot line, the columnar chunks 24b as shown in FIG. 4 are formed. By changing the position of the fixing table 33 alternately in this way, the columns 24, each of which is a stack of eight columnar chunks 24a, 24b, 24c, 24d, 24e, 24f, 24g, and 24h as shown in FIG. 4, are consecutively formed on the projections 22, whereby the thin film negative electrode active material layer 23 is obtained.

When the alloy-based negative electrode active material is, for example, a silicon oxide represented by SiO, where 0.05<a<1.95, the columns 24 may be formed so that the columns 24 each have a concentration gradient of oxygen in the thickness direction thereof. Specifically, the oxygen content may be made higher in a proximity of the negative electrode current collector 21, and may be decreased with distance away from the negative electrode current collector 21. This further improves the bonding between the projections 22 and the columns 24.

When the raw material gas is not supplied from the nozzle 34, the columns 24 mainly composed of silicon or tin simple substance are formed. When the negative electrode current collector 12a is used instead of the negative electrode current collector 21, and the fixing table 33 is not moved and fixed in the horizontal direction, the thin film negative electrode active material layer 12b can be formed.

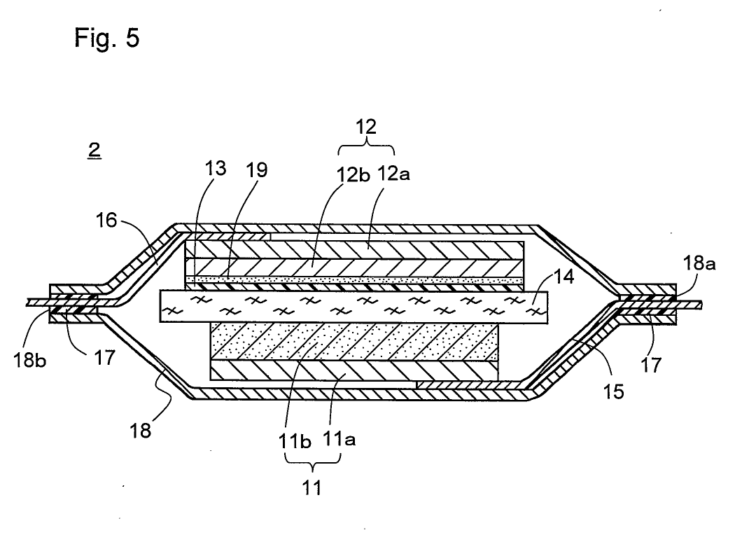

FIG. 5 is a longitudinal sectional view schematically showing a configuration of a lithium ion secondary battery 2 according to another embodiment of the present invention. The lithium ion secondary battery 2 is analogous to the lithium ion secondary battery 1 shown in FIG. 1, and the corresponding parts thereof are designated by the same reference numerals and the description thereof will be omitted.

The lithium ion secondary battery 2 is characterized by further comprising an oxide layer 19 provided between the thin film negative electrode active material layer 12b and the ion-permeable resin layer 13, and has the same configuration as that of the lithium ion secondary battery 1 except the above.

The oxide layer 19 is interposed between the thin film negative electrode active material layer 12b and the ion-permeable resin layer 13. Forming the oxide layer 19 further improves the adhesion between the thin film negative electrode active material layer 12b and the ion-permeable resin layer 13, making it possible to provide the lithium ion secondary battery 2 having a long service life. The oxide layer 19 is made of SiO₂ or mainly made of SiO₂. The oxide layer 19 may contain inevitable impurities.

The oxide layer 19 made of SiO₂ can be formed by a vapor phase method in the same manner as the negative electrode active material layer 12b. The oxide layer 19 is preferably formed by a vapor phase method on the surface of the negative electrode active material layer 12b.

The thickness of the oxide layer 19 is preferably 0.1 to 3 pin. When the thickness of the oxide layer 19 is less than 0.1 μm, the effect of bonding the thin film negative electrode active material layer 12b and the ion-permeable resin layer 13 may become insufficient. When the thickness of the oxide layer exceeds 3 μm, the ion conductivity between the positive electrode 11 and the negative electrode 12 may become insufficient, causing the battery characteristics such as output characteristics and cycle characteristics to deteriorate.

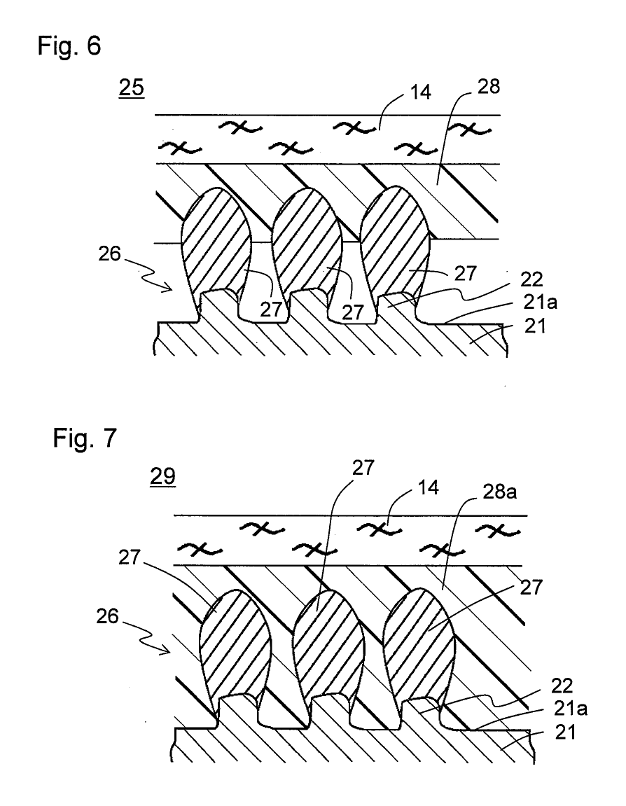

FIG. 6 is a longitudinal sectional view schematically showing a configuration of a main part of a negative electrode 25 according to the another embodiment of the present invention. For convenience of description, in FIG. 6, the side of the negative electrode current collector 21 is regarded as the lowermost; and the side of the separator 14 is regarded as the uppermost. The negative electrode 25 is analogous to the negative electrode 20, and the corresponding parts thereof are designated by the same reference numerals and the description thereof will be omitted. The negative electrode 25 comprises the negative electrode current collector 21, the thin film negative electrode active material layer 26, and the ion-permeable layer 28, and has the same configuration as that of the negative electrode 20 except the above.

The thin film negative electrode active material layer 26 includes a plurality of spindle-shaped columns 27 (hereinafter simply referred to as “columns 27”). The columns 27 contain an alloy-based negative electrode active material. This provides the following advantages. On the surface of the thin film negative electrode active material layer 26, an area in which the columns 27 is present and an area in which the column 27 is not present appear alternately. This makes apparent asperities. The gaps between a pair of the columns 27 adjacent to each other make apparent cracks.

When compared, the column 27 has a spindle shape, while the column 24 has a columnar shape. As such, the apparent asperities or cracks formed by the columns 27 are larger than those formed by the columns 24. In particular, the apparent cracks are each formed into a funnel shape, which increases an area that can contact with the ion-permeable layer 28. The ion-permeable layer 28 is therefore formed not only on the top surfaces of the columns 27 but also on the side surfaces of the columns 27. The side surface of the column 27 is a surface of the column 27 facing the gap formed with another column 27 adjacent thereto. This allows the asperities and cracks to exert a remarkable anchor effect, thus further improving the adhesion between the thin film negative electrode active material layer 26 and the ion-permeable resin layer 28.

The axis-to-axis distance between a pair of the columns 27 adjacent to each other is preferably 10 μm to 50 μm. When the axis-to-axis distance is within this range, the polymer solution can smoothly enter the gaps between the columns 27, and the ion-permeable resin layer 28 can be easily formed on the side surfaces of the columns 27. The shape of the column 27 on the orthographic view seen from vertically above of the column 27 is a circle. The axis of the column 27 is a virtual line passing through the center of the circle and extending along the normal to the surface of the negative electrode current collector 21. If the circle is not a perfect circle, the center of a smallest circle circumscribing the non-perfect circle is regarded as the center of the non-perfect circle. Since the plurality of the columns 27 grow almost in the same direction, the axes of these columns 27 are almost parallel to each other.

When the column 27 has a spindle shape, a comparatively large space is created around the projections 22. This space absorbs the expansion and contraction of the alloy-based negative electrode active material contained in the columns 27. As such, even if charge and discharge are repeated, cracks are unlikely to occur in the columns 27. This suppresses the formation of byproducts resulted from the contact of the newly created surfaces with the non-aqueous electrolyte, useless consumption of the non-aqueous electrolyte, and the like can be prevented, and thus deterioration in various battery performances can be prevented.

When the axis-to-axis distance is less than 10 μm, the polymer solution may not readily enter the gaps between the columns 27, and the expansion in volume of the alloy-based negative electrode active material contained in the columns 27 may not be absorbed sufficiently. When the axis-to-axis distance exceeds 50 μm, the number of the columns 27 becomes too small, and the capacity of the negative electrode 25 may be reduced. The columns 27 can be formed in the same manner as the columns 24 with the electron beam vapor deposition apparatus 30 as shown in FIG. 8, by suitably adjusting the angle for tilting the fixing table 33, the thickness of one columnar chunk, and the number of stacking of columnar chunks.

The ion-permeable resin layer 28 having entered the gaps between the columns 27 is present only in the upper area of the gaps between the columns 27 and does not reach the surface 21a of the negative electrode current collector 21. However, the entering of the ion-permeable resin layer 28 into the upper area of the gaps between the columns 27 allows the anchor effect of the apparent cracks (the gaps between the column 27) to be exerted sufficiently. As a result, the adhesion between the thin film negative electrode active material layer 26 and the ion-permeable resin layer 28 is further improved, and deterioration in various battery performances such as cycle characteristics and output characteristics are remarkably prevented.

FIG. 7 is a longitudinal sectional view schematically showing a configuration of a main part of a negative electrode 29 according to the another embodiment of the present invention. The negative electrode 29 is analogous to the negative electrode 25, and the corresponding parts thereof are designated by the same reference numerals and the description thereof will be omitted. The negative electrode 29 is characterized by comprising the ion-permeable layer 28a. The ion-permeable resin layer 28a enters the gaps between a pair of the columns 27 adjacent to each other and reaches the surface 21a of the negative electrode current collector 21. The gaps between the columns 27 are filled with the ion-permeable resin layer 28a. The ion-permeable resin layer 28a, like the ion-permeable resin layers 13 and 28, contains a polymer and a lithium salt as a supporting salt.

As such, the same effect as obtained in the negative electrode 25 can be obtained. The entering of the ion-permeable resin layer 28a throughout the gaps between the columns 27 allows the anchor effect of the film-film negative electrode active material layer 26 to be exerted more sufficiently. As a result, the adhesion between the surface of the thin film negative electrode active material layer 26 and the ion-permeable resin layer 28a is furthermore improved, making it possible to reliably prevent the columns 27 from being separated from the projections 22 due to the expansion and contraction of the alloy-based negative electrode active material.

In still another type of negative electrode (not shown), the ion-permeable resin layer may be formed on the surfaces of the columns 27. In this case, the ion-permeable resin layer may be provided such that ion-permeable resin layers provide on a pair of the adjacent columns 27 are spaced from each other. The ion-permeable resin layer, because of its flexibility, can follow the changes in volume of the alloy-based negative electrode active material contained in the columns 27. For this reason, by configuring in such a manner, the newly created surfaces with the non-aqueous electrolyte can be prevented and the expansion in volume of the alloy-based negative electrode active material can be absorbed at the same time at a high level.

The lithium ion secondary batteries 1 and 2 shown in FIGS. 1 and 5 include a stacked electrode assembly, but not limited thereto, and may include a wound electrode assembly. The lithium ion secondary battery of this embodiment may be in various forms such as a flat battery including a stacked electrode assembly, a cylindrical battery including a wound electrode assembly, and a prismatic battery including a flat wound electrode assembly.

The lithium ion secondary battery of the present invention can be used for applications similar to the conventional lithium ion secondary batteries, and is particularly useful as a power source of portable electronic devices, such as personal computers, cellular phones, mobile devices, personal digital assistants (PDAs), portable game machines, and camcorders. The lithium ion secondary battery of the present invention can be expected to be used as a secondary battery for assisting an electro motor in a hybrid electric vehicle, fuel cell-powered automobile, and the like; a power source for driving an electrically-powered tool, cleaner, robot, and the like; a power source for a plug-in HEV; and other uses.

### EXAMPLES

The present invention is specifically described below with reference to examples, comparative examples, and experimental examples.

### Example 1

### (1) Preparation of Positive Electrode Active Material

To an aqueous NiSO₄ solution, cobalt sulfate was added such that Ni:Co=8.5:1.5 (molar ratio), to prepare an aqueous solution having a metal ion concentration of 2 mol/L. To the resultant aqueous solution, a 2 mol/L sodium hydroxide solution was gradually added dropwise to neutralize the aqueous solution, whereby a ternary precipitate represented by Ni_{0.85}CO_{0.15}(OH)₂ was produced by coprecipitation. The precipitate was collected by filtration, washed with water, and dried at 80° C., to give a composite hydroxide.

This composite hydroxide was heated at 900° C. in air for 10 hours, to give a composite oxide represented by Ni_{0.85}CO_{0.15}O. Subsequently, the composite oxide was mixed with a monohydrate of lithium hydroxide such that the total number of Ni and Co atoms became equal to the number of Li atoms, and heated at 800° C. in air for 10 hours, to give a lithium-nickel-containing composite oxide represented by LiNi_{0.85}Co_{0.15}O₂. In such a manner, a positive electrode active material including secondary particles having an average particle diameter of 10 μm was obtained.

### (2) Production of Positive Electrode

First, 93 g of the positive electrode active material powder obtained above, 3 g of acetylene black (conductive agent), 4 g of polyvinylidene fluoride powder (binder), and 50 mL of N-methyl-2-pyrrolidone were mixed sufficiently to prepare a positive electrode material mixture slurry. The positive electrode material mixture slurry thus prepared was applied onto both surfaces of a 15-μm-thick aluminum foil (positive electrode current collector), then dried and rolled, whereby a positive electrode active material layer having a thickness of 130 μm was formed.

### (3) Production of Negative Electrode

FIG. 9 is a side view schematically showing a configuration of the vapor deposition apparatus 40. The vapor deposition apparatus 40 includes a vacuum chamber 41, a current collector transporting means 42, a raw material gas supplying means 48, a plasma generating means 49, silicon targets 50a and 50b, a shielding plate 51, and an electron beam heating means (not shown). The vacuum chamber 41 is a pressure-tight container and contains in its interior space the current collector transporting means 42, the raw material gas supplying means 48, the plasma generating means 49, the silicon targets 50a and 50b, the shielding plate 51, and the electron beam heating means.

The current collector transporting means 42 includes a feed roller 43, a can 44, a pickup roller 45, and guide rollers 46 and 47. The feed roller 43, the can 44, and the guide rollers 46 and 47 are provided so as to be rotatable around their axes. On the feed roller 43, a long negative electrode current collector 12a is wound around. The can 44 has a larger diameter than the other rollers and has a cooling means (not shown) in its interior. When the negative electrode current collector 12a is transported on the surface of the can 44, the negative electrode current collector 12a is cooled. Vapor of the alloy-based negative electrode active material deposits on the cooled negative electrode current collector 12a, to be formed into a thin film.

The pickup roller 45 is provided so as to be rotatable around its axis by a driving means (not shown). One end of the negative electrode current collector 12a is fixed onto the pickup roller 45, and by the rotation of the pickup roller 45, the negative electrode current collector 12a is fed from the feed roller 43 and transported on the guide roller 46, the can 44, and the guide roller 47. Then, the negative electrode 12 with a thin film of the alloy-based negative electrode active material formed thereon is wound on the pickup roller 45.

The raw material gas supplying means 48 supplies a raw material gas of, for example, oxygen and nitrogen into the vacuum chamber 41. The plasma generating means 49 allows the raw material gas supplied from the raw material gas supplying means 48 to form plasma thereof. The silicon targets 50a and 50b are used when forming a thin film containing silicon. The shielding plate 51 is provided so as to be movable in a horizontal direction vertically below the can 44 and vertically above the silicon targets 50a and 50b. The position in the horizontal direction of the shielding plate 51 is suitable adjusted according to the growing state of the thin film on the surface of the negative electrode current collector 12a. The electron beam heating means irradiates the silicon targets 50a and 50b with electron beam to heat the targets 50a and 50b, so that vapor of silicon is generated.

By using the vapor deposition apparatus 40, a thin film negative electrode active material layer (here, a silicon thin film) having a thickness of 5 μm was formed on the surface of the negative electrode current collector 12a under the following conditions, thereby to form the negative electrode 12.

Pressure in vacuum chamber 41: 8.0×10⁻⁵ Torr

Negative electrode current collector 12a: electrolytic copper foil of 50 m in length, 10 cm in width, and 35 μm in thickness (available from FURUKAWA CIRCUIT FOIL Co., Ltd.)

Rate of winging of negative electrode current collector 12a on pickup roller 45 (transportation rate of negative electrode current collector 12a): 2 cm/min

Raw material gas: not supplied

Targets 50a and 50b: single crystal silicon of 99.9999% purity (available from Shin-Etsu Chemical Co., Ltd.)

Accelerating voltage of electron beam: −8 kV

Emission of electron beam: 300 mA

The obtained negative electrode 12 was cut into a size of 35 mm×185 mm to give a negative electrode plate. On the surface of the thin film negative electrode active material layer (silicon thin film) of this negative electrode plate, lithium metal was vapor deposited. By vapor depositing lithium metal, lithium was supplemented in the thin film negative electrode active material layer in an amount corresponding to the irreversible capacity stored at the time of initial charge and discharge. The vapor deposition of lithium metal was performed using a resistance heating vapor deposition apparatus (available from ULVAC, Inc.) in the following manner. Lithium metal was placed in the tantalum boat in the resistance heating vapor deposition apparatus, and the negative electrode 12 was fixed so that the thin film negative electrode active material layer faced the tantalum boat. Then, the vapor deposition was carried out for 10 minutes in an argon atmosphere, while a current of 50 A was allowed to flow through the tantalum boat. A negative electrode plate used in the present invention was thus obtained.

### (4) Formation of Ion-permeable Resin Layer

In a mixed solvent containing ethylene carbonate and propylene carbonate in a volume ratio of 1:1, LiPF₆ was dissolved at a concentration of 1.0 mol/L, to prepare a non-aqueous electrolyte. To the non-aqueous electrolyte thus prepared, PVDF was added and heated to 80° C., to prepare a 15% by weight polyvinylidene fluoride solution (hereinafter referred to as a “PVDF solution”). The viscosity at 80° C. of the PVDF solution was 0.3 cps.

The negative electrode plate obtained above was immersed in the PVDF solution for 1 minute to allow the negative electrode plate to be impregnated with the PVDF solution. The negative electrode plate impregnated with the PVDF solution was placed on a glass plate, and dried with hot air at 80° C. for 10 minutes. As a result, on the surface of the negative electrode plate, an ion-permeable resin layer having a thickness of about 5 pin was formed.

### (5) Fabrication of Stack-type Battery

The positive electrode plate and the negative electrode plate with the ion-permeable resin layer formed thereon obtained above were stacked with a polyethylene microporous film (separator, trade name: Hipore, thickness 20 μm, available from Asahi Kasei Corporation) interposed therebetween, to form an electrode assembly. In stacking, the positive electrode plate and the negative electrode plate were arranged such that the positive electrode active material layer and the thin film negative electrode active material layer faced each other with the separator interposed therebetween, and the separator and the thin film negative electrode active material layer faced each other with the ion-permeable resin layer interposed therebetween. Next, one end of a positive electrode lead made of aluminum was welded to the positive electrode current collector in the positive electrode plate, and one end of an negative electrode lead made of nickel was welded to the negative electrode current collector in the negative electrode plate.

The electrode assembly thus formed was inserted into a housing case made of aluminum laminate sheet together with an electrolyte. For the electrolyte, a non-aqueous electrolyte obtained by dissolving LiPF₆ at a concentration of 1.0 mol/L in a mixed solvent containing ethylene carbonate and ethyl methyl carbonate at a volume ratio of 1:1 was used. Then, the positive electrode lead and the negative electrode lead were guided outside the housing case from the openings of the housing case. Subsequently, each of the openings was sealed by welding, while the pressure in the interior of the housing case was reduced to vacuum, whereby the lithium ion secondary battery of the present invention was fabricated.

### Example 2

The lithium ion secondary battery of the present invention was fabricated in the same manner as Example 1, except that the negative electrode was produced in the following manner.

### [Production of Negative Electrode]

On the surface of an iron roller having a diameter of 50 mm, chromic oxide was flame sprayed to form a ceramic layer having a thickness of 100 μm. On the surface of the ceramic layer thus formed, holes being circular depressions each having a diameter of 12 μm and a depth of 8 μm were formed by laser machining, whereby a projection-forming roller was produced. These holes were arranged in a close-packed pattern, with an axis-to-axis distance between a pair of adjacent holes being 20 μm. The bottom of these holes was substantially planar at its center, and the edge where the bottom meets the side was round.

An alloy copper foil (trade name: HCL-02Z, thickness: 20 μm, available from Hitachi Cable) containing 0.03% by weight of zirconia to the total amount was heated in an argon gas atmosphere at 600° C. for 30 minutes for annealing. This alloy copper foil was passed through a press-contact portion at which the two projection-forming rolls were press-fitted to each other, at a line pressure of 2 t/cm, to press-mold both surfaces of the alloy copper foil, whereby a negative electrode current collector used in the present invention was produced. The cross section of the negative electrode current collector thus produced in its thickness direction was observed under a scanning electron microscope. The result found that projections were formed on the surfaces of the negative electrode current collector, and the average height of the projections was about 8 μm.

On the surfaces of the projections of the negative electrode current collector, columns were formed using a commercially available vapor deposition apparatus (available from ULVAC, Inc.) having the same structure as the electron beam vapor deposition apparatus 30 as shown in FIG. 8. Conditions for vapor deposition were as follows. The fixing table on which a negative electrode current collector of 35 mm×185 mm in size was fixed tilted alternately so as to move between the position forming an angle α=60° with the horizontal line (position shown by the solid line in FIG. 8) and the position forming an angle (180-α)=120° with the horizontal line (position shown by the dash-dot line in FIG. 8). In such a manner, a plurality of columns each comprising a stack of eight columnar chunks as shown in FIGS. 3 and 4 were formed. Each column has grown along the extending direction of the projection from the top surface or a side surface near the top surface of the projection.

Raw material of negative electrode active material (evaporation source): silicon, purity 99.9999%, available from Kojundo Chemical Laboratory Co., Ltd.

Oxygen released from nozzle: purity 99.7%, available from Nippon Sanso Corporation

Flow rate of oxygen released from nozzle: 80 sccm

Angle α: 60°

Accelerating voltage of electron beam: −8 kV

Emission: 500 mA

Duration of vapor deposition: 3 minutes

Thickness T of the thin film negative electrode active material layer thus formed was 16 μm. The thickness of the thin film negative electrode active material layer was determined as an average of the lengths of ten columns measured from the peak of a projection to the peak of a column on the projection, obtained by observing a cross section of the negative electrode in the thickness direction thereof under a scanning electron microscope and measuring and averaging the lengths. Further, the oxygen content in the thin film negative electrode active material layer was measured by a combustion method. The result found that the composition of the compound forming the thin film negative electrode active material layer was SiO_{0.5}.

Next, lithium metal was vapor deposited on the surface of the thin film negative electrode active material layer. By vapor depositing lithium metal, lithium was supplemented in an amount corresponding to the irreversible capacity stored in the thin film negative electrode active material layer at the time of initial charge and discharge. The vapor deposition of lithium metal was performed using a resistance heating vapor deposition apparatus (available from ULVAC, Inc.) in the following manner. Lithium metal was placed in the tantalum boat in the resistance heating vapor deposition apparatus, and the negative electrode was fixed so that the thin film negative electrode active material layer faced the tantalum boat. Then, the vapor deposition was carried out for 10 minutes in an argon atmosphere, while a current of 50 A was allowed to flow through the tantalum boat.

### Example 3

The lithium ion secondary battery of the present invention was fabricated in the same manner as Example 1, except that the support salt (LiPF₆) was not added to the ion-permeable resin layer.

### Comparative Example 1

A lithium ion secondary battery was fabricated in the same manner as Example 1, except that the ion-permeable resin layer was not formed.

### Experimental Example 1

The lithium ion secondary batteries produced in Examples 1 to 3 and Comparative Example 1 were evaluated through the following experiments.

### (Battery Capacity Evaluation)

The lithium ion secondary batteries of Examples 1 to 3 and Comparative Example 1 were subjected a charge/discharge cycle under the following conditions. The charge/discharge cycle was repeated three times in total to measure a discharge capacity at the third cycle. The results are shown in Table 1.

Constant current charge: 280 mA (0.7 C), end-of-charge voltage 4.2 V

Constant voltage charge: end-of-charge current 20 mA (0.05 C), duration of interval 20 minutes

Constant current discharge: current 80 mA (0.2 C), end-of-discharge voltage 2.5 V, duration of interval 20 minutes

### (Cycle Characteristics)

In an environment at 20° C., the batteries were charged at a constant current of 280 mA (0.7 C) until the voltage reached 4.2 V, then charged at a constant voltage of 4.2 V until the current reached 20 mA (0.05 C), and discharged at a constant current of 80 mA (0.2 C) until the voltage reached 2.5 V. The discharge capacity at this time was measured as an initial discharge capacity. Thereafter, a charge/discharge was repeated with the discharge current value set at 400 mA (1C). After 100 cycles were completed, a constant current discharge was performed at 80 mA (0.2 C). The discharge capacity at this time was measured as a 100th cycle discharge capacity. A ratio of the 100th cycle discharge capacity to the initial discharge capacity was calculated as a percentage, which was referred to as a cycle capacity retention rate (%). The results are shown in Table 1.

### (Battery Swelling)

The thicknesses of the electrode assembly before cycle characteristics evaluation and after 100 cycles were measured. The difference between the measured thicknesses of the electrode assembly before cycle characteristics evaluation and after 100 cycles was calculated as a battery swelling. The results are shown in Table 1.

TABLE 1

| | Battery capacity | Cycle capacity | Battery |
|---|---|---|---|
| | evaluation | retention rate | swelling |
| | (mAh) | (%) | (mm) |
| Example 1 | 396.4 | 74.0 | 0.101 |
| Example 2 | 398.8 | 90.5 | 0.064 |
| Example 3 | 396.1 | 74.4 | 0.098 |
| Comparative | 391.7 | 49.5 | 0.41 |
| Example 1 | | | |

Table 1 shows that the lithium ion secondary batteries of Examples 1 to 3 had high cycle capacity retention rates, indicating that the deterioration in cycle characteristics was small and the battery swelling was suppressed. This was presumably because the ion-permeable resin layer was formed on the surface of the thin film negative electrode active material layer, and even when cracks occur in the alloy-based negative electrode active material and newly created surfaces appear, the ion-permeable resin layer prevented the contact of the newly created surfaces with the non-aqueous electrolyte.

Comparison between Example 1 and Example 2 shows that in the batteries in which the thin film negative electrode active material layer included a plurality of columns, the cycle characteristics and the battery swelling were remarkably suppressed. This was presumably because the thin film negative electrode active material layer included a plurality of columns, and therefore, the adhesion between the thin film negative electrode active material layer and the ion-permeable resin layer was further improved.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A lithium ion secondary battery comprising:
a positive electrode including a positive electrode active material layer containing a positive electrode active material, and a positive electrode current collector;
a negative electrode including a thin film negative electrode active material layer containing an alloy-based negative electrode active material, and a negative electrode current collector;
a separator interposed between the positive electrode and the negative electrode; and
an ion-permeable resin layer coating at least part of a surface of the thin film negative electrode active material layer.

2. The lithium ion secondary battery in accordance with claim 1, wherein the thin film negative electrode active material layer has a thickness of 1 μm to 20 μm.

3. The lithium ion secondary battery in accordance with claim 1, wherein the surface of the thin film negative electrode active material layer has a surface roughness of 0.1 to 2 μm.

4. The lithium ion secondary battery in accordance with claim 1, wherein the thin film negative electrode active material layer includes a plurality of columns, the plurality of columns contain the alloy-based negative electrode active material, a gap is present between a pair of the columns adjacent to each other, and the ion-permeable resin layer coats at least part of surfaces of the plurality of columns.

5. The lithium ion secondary battery in accordance with claim 4, wherein the ion-permeable resin layer fills at least part of the gap.

6. The lithium ion secondary battery in accordance with claim 4, wherein the pair of the columns adjacent to each other has an axis-to-axis distance of 10 μm to 50 μm.

7. The lithium ion secondary battery in accordance with claim 1, wherein at least part of the surface of the thin film negative electrode active material layer has asperities or cracks.

8. The lithium ion secondary battery in accordance with claim 7, wherein each of the cracks on the surface of the thin film negative electrode active material layer has a length of 0.1 μm to 20 μm, a width of 0.1 μm to 5 μm, and a depth of 0.1 μm to 20 μm.

9. The lithium ion secondary battery in accordance with claim 1, wherein the ion-permeable resin layer contains a polymer.

10. The lithium ion secondary battery in accordance with claim 9, wherein the polymer is at least one selected from the group consisting of fluorocarbon resin, polyacrylonitrile, polyethylene oxide, and polypropylene oxide.

11. The lithium ion secondary battery in accordance with claim 9, wherein the ion-permeable resin layer contains a supporting salt in addition to the polymer, the supporting salt containing lithium ions.

12. The lithium ion secondary battery in accordance with claim 1 further comprising an oxide layer containing SiO₂, the oxide layer being provided between the thin film negative electrode active material layer and the ion-permeable resin layer.

13. The lithium ion secondary battery in accordance with claim 1, wherein the alloy-based negative electrode active material is at least one selected from a silicon-based active material and a tin-based active material.
